(19) United States
(12) Patent Application Publication
(10) Pub. No.: US 2025/0291038 A1
(43) Pub. Date: Sep. 18, 2025

(54) DISTANCE INFORMATION ACQUISITION DEVICE AND DISTANCE INFORMATION ACQUISITION METHOD

(71) Applicant: CANON KABUSHIKI KAISHA, Tokyo (JP)

(72) Inventor: HIDEYUKI ITO, Tokyo (JP)

(21) Appl. No.: 18/475,981

(22) Filed: Sep. 27, 2023

(30) Foreign Application Priority Data
Oct. 13, 2022 (JP) 2022-164599

(51) Int. Cl. G01S 7/4861; G01S 7/4865; G01S 17/18; G01S 17/931

(52) U.S. Cl. CPC G01S 7/4861; G01S 7/4865; G01S 17/18; G01S 17/931

(57) ABSTRACT

A distance information acquisition device includes a light receiving unit that detects a pulsed light reflected by an object in a measurement target area, and a signal processing unit that acquires information concerning a distance to the object based on information detected by the light receiving unit. The light receiving unit includes a counter that counts the number of pulsed light detected in each of distance ranges defined according to a time period from timing the pulsed light is emitted to timing the pulsed light is detected, and outputs one-bit signals indicating the pulsed light is detected, when a count value of the pulsed light is not less than a predetermined value of 2 or more. The one-bit signal constitutes a micro-frame, the micro-frames acquired for the same distance range constitute a sub-frame, and the sub-frames acquired for different distance ranges constitute a ranging frame for generating a distance image.

### BACKGROUND OF THE INVENTION

### Field of the Invention

The present invention relates to a distance information acquisition device and a distance information acquisition method.

### Description of the Related Art

As one of distance measuring methods for measuring a distance to an object using light, a distance measuring method called a TOF (Time Of Flight) method is known. The TOF method is a method of measuring a distance to an object based on a time period from emission of light toward the object to detection of light reflected by the object. U.S. Patent Application Publication No. 2017/0052065 describes a distance measuring device that measures a distance to an object by applying the TOF method to a photon detection sensor using a SPAD (Single Photon Avalanche Diode) element.

In the distance measuring method described in U.S. Patent Application Publication No. 2017/0052065, a short pulse laser beam repeatedly emitted at a predetermined frequency is irradiated to an object, and the reflected light from the object is detected with synchronizing the irradiation of the laser beam and the detection by the SPAD sensor. That is, a specific exposure period (hereinafter referred to as a gating period) is set in the SPAD sensor in association with the emission timing of the laser light, and photon detection is performed in the exposure period. Then, the gating period is sequentially shifted, and a signal corresponding to each of the plurality of gating periods is acquired. This result is recorded in a histogram memory, and a distance to the object is calculated from the histogram peak.

However, in the method described in U.S. Patent Application Publication No. 2017/0052065, when the incidence of disturbance light or noise of the SPAD sensor occurs during each gating period, these noises are added as original signals to the histogram as they are, and the accuracy of distance measurement is lowered in some cases.

### SUMMARY OF THE INVENTION

An object of the present invention is to provide a distance information acquisition device and a distance information acquisition method capable of obtaining distance information with higher accuracy by reducing influence of noise.

According to an embodiment of the present disclosure, there is provided a distance information acquisition device including a light receiving unit including a photoelectric conversion unit and configured to detect a pulsed light emitted from a light emitting unit and reflected by an object in a measurement target area, and a signal processing unit configured to acquire information concerning a distance to the object based on information detected by the light receiving unit, wherein the light receiving unit includes a counting unit configured to count the number of pulsed light reflected by the object and incident on the light receiving unit, wherein the counting unit is configured to count the number of pulsed light detected in each of a plurality of distance ranges defined according to a time period from a timing at which the pulsed light is emitted by the light emitting unit to a timing at which the pulsed light is detected by the light receiving unit, and output one-bit signals each indicating that the pulsed light is detected, when a count value of the pulsed light is equal to or greater than a predetermined value of 2 or more, wherein each of the one-bit signals constitutes a micro-frame, wherein a plurality of micro-frames acquired for the same distance range constitutes a sub-frame, and wherein a plurality of sub-frames acquired for different distance ranges constitutes a ranging frame used for generating one distance image.

According to another embodiment of the present disclosure, there is provided a photoelectric conversion device including a photoelectric conversion unit including a photoelectric conversion element and configured to output a pulsed signal in response to an incident of photon, and a counting unit configured to count the number of pulsed light output from the photoelectric conversion unit, wherein the counting unit is configured to output a one-bit signal indicating that the pulsed light is detected, when a count value of the pulsed light is equal to or greater than a predetermined value of 2 or more.

According to still another embodiment of the present disclosure, there is provided a distance information acquisition method of acquiring distance information concerning an object based on a detection timing of light irradiated to the object, the method including irradiating a pulsed light to a measurement target area and detecting the pulsed light reflected by the object in the measurement target area, counting the number of the pulsed light detected in each of a plurality of distance range defined according to a time period from a timing at which the pulsed light is emitted to a timing at which the pulsed light is detected, outputting a one-bit signal indicating that the pulsed light is detected, when a count value of the pulsed light is equal to or greater than a predetermined value of 2 or more, and calculating a plural bit signal by accumulating values of a plurality of one-bit signals for each distance ranges, and determining a distance range having a plural bit signal of largest value as a distance measurement result of the object.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a distance information acquisition device according to a first embodiment of the present invention.

FIG. 2 is an equivalent circuit diagram illustrating a configuration example of a pixel in the distance information acquisition device according to the first embodiment of the present invention.

FIG. 3A, FIG. 3B, and FIG. 3C are diagrams illustrating the basic operation of a photoelectric conversion element in the distance information acquisition device according to the first embodiment of the present invention.

FIG. 4A is a diagram illustrating a configuration example of a counter in the distance information acquisition device according to the first embodiment of the present invention.

FIG. 4B is a diagram illustrating an operation of the counter in the distance information acquisition device according to the first embodiment of the present invention.

FIG. 5 is a diagram illustrating a configuration example of a ranging frame in a distance information acquisition method according to the first embodiment of the present invention.

FIG. 6 is a diagram illustrating an outline of the distance information acquisition method in the distance information acquisition device according to the first embodiment of the present invention.

FIG. 7 is a flowchart explaining the distance information acquisition method according to the first embodiment of the present invention.

FIG. 8 and FIG. 9 are diagrams illustrating examples of histogram information indicating a frequency for each distance range to be measured.

FIG. 10 is a diagram illustrating a configuration example of a ranging frame in a distance information acquisition method according to a second embodiment of the present invention.

FIG. 11A and FIG. 11B are diagrams illustrating a configuration example of a movable object according to a third embodiment of the present invention.

### DESCRIPTION OF THE EMBODIMENTS

Preferred embodiments of the present invention will now be described in detail in accordance with the accompanying drawings.

### First Embodiment

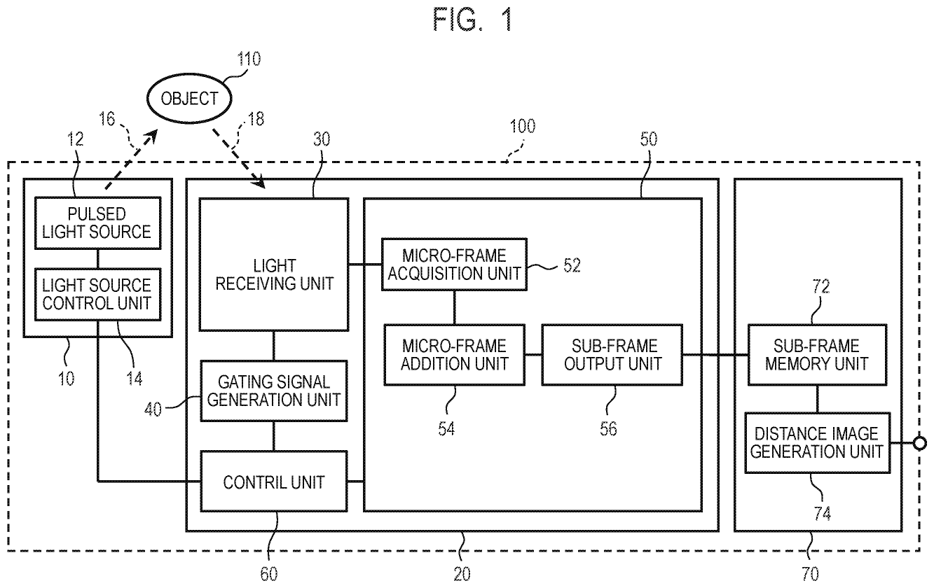

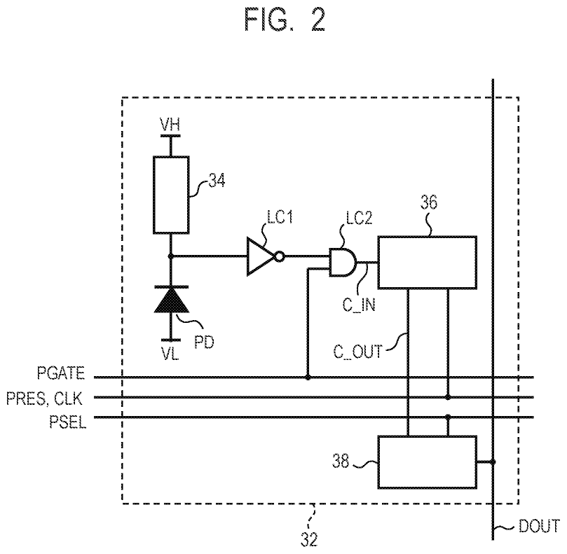

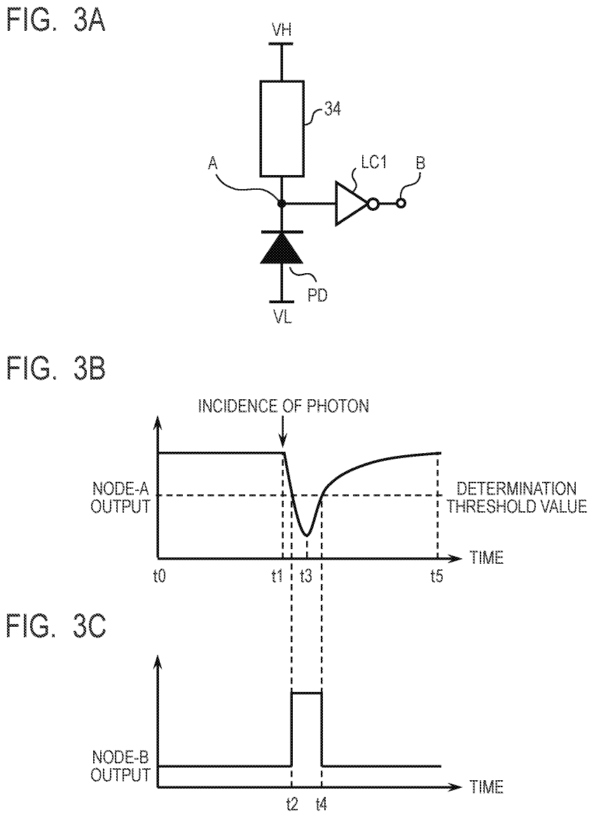

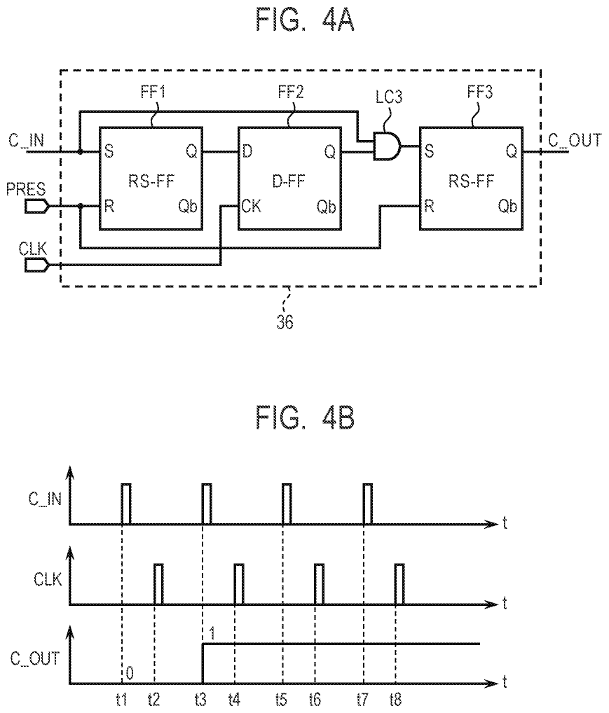

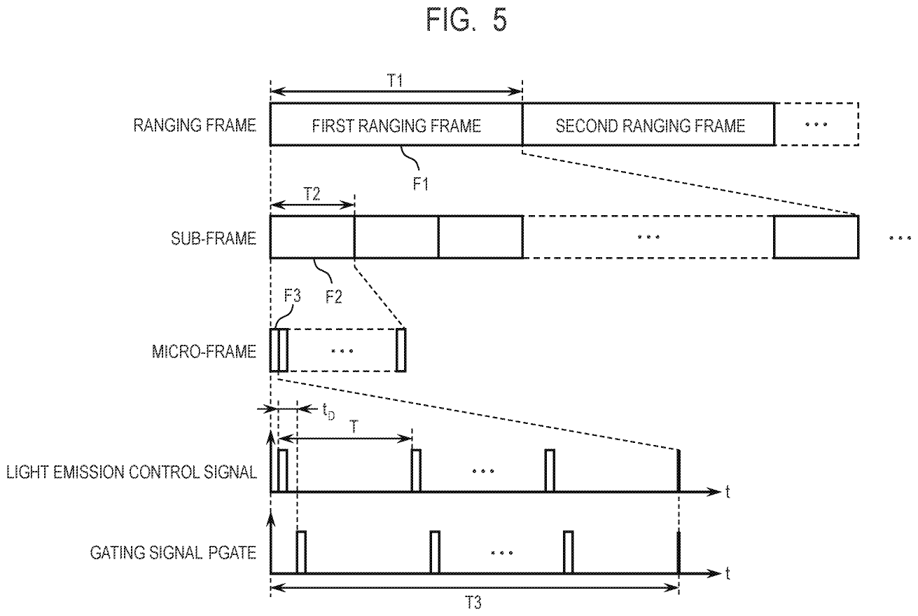

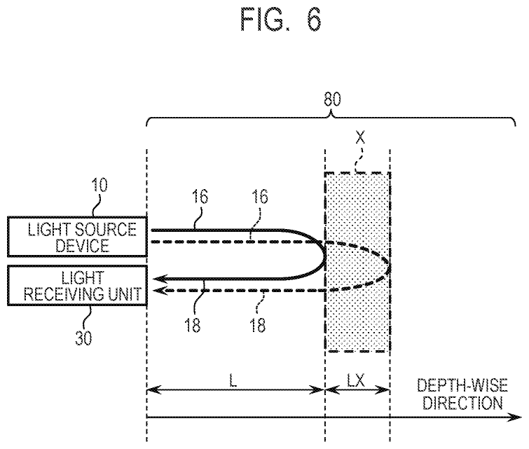

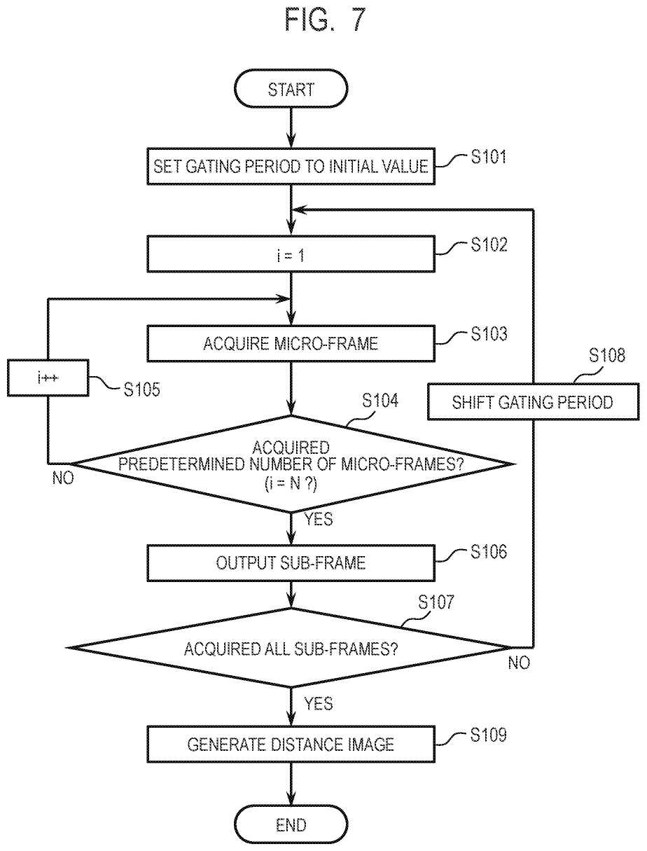

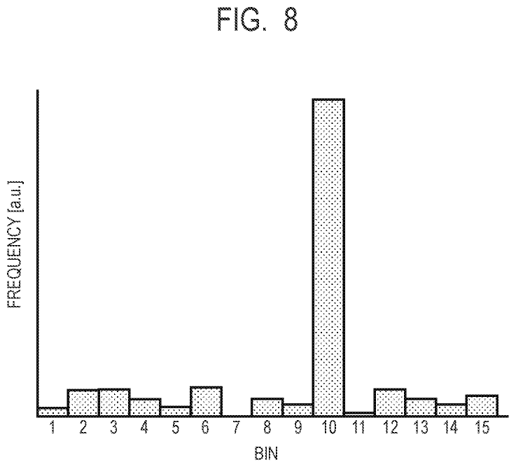

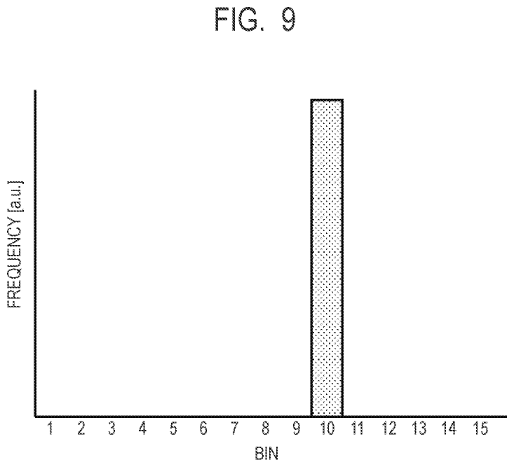

A distance information acquisition device and a distance information acquisition method according to a first embodiment of the present invention will be described with reference to FIG. 1 to FIG. 9. FIG. 1 is a block diagram illustrating a schematic configuration of a distance information acquisition device according to the present embodiment. FIG. 2 is an equivalent circuit diagram illustrating a configuration example of a pixel in the distance information acquisition device according to the present embodiment. FIG. 3A, FIG. 3B, and FIG. 3C are diagrams illustrating the basic operation of a photoelectric conversion element in the distance information acquisition device according to the present embodiment. FIG. 4A and FIG. 4B are diagrams illustrating a configuration example and an operation of a counter in the distance information acquisition device according to the present embodiment. FIG. 5 is a diagram illustrating a configuration example of a ranging frame in a distance information acquisition method according to the present embodiment. FIG. 6 is a diagram illustrating an outline of the distance information acquisition method in the distance information acquisition device according to the present embodiment. FIG. 7 is a flowchart explaining the distance information acquisition method according to the present embodiment. FIG. 8 and FIG. 9 are diagrams illustrating examples of histogram information indicating the frequency for each distance range to be measured.

First, a schematic configuration of the distance information acquisition device according to the present embodiment will be described with reference to FIG. 1. As illustrated in FIG. 1, the distance information acquisition device 100 according to the present embodiment includes a light source device 10, a light detection device 20, and an arithmetic processing device 70. The light source device 10 includes a pulsed light source 12 and a light source control unit 14. The light detection device 20 includes a light receiving unit 30, a gating signal generation unit 40, a signal processing unit 50, and a control unit 60. The signal processing unit 50 includes a micro-frame acquisition unit 52, a micro-frame addition unit 54, and a sub-frame output unit 56. The arithmetic processing device 70 includes a sub-frame memory unit 72 and a distance image generation unit 74.

The pulsed light source 12 is connected to the light source control unit 14. The light receiving unit 30 is connected to the micro-frame acquisition unit 52 and the gating signal generation unit 40. The micro-frame acquisition unit 52 is connected to the micro-frame addition unit 54. The micro-frame addition unit 54 is connected to the sub-frame output unit 56. The control unit 60 is connected to the light source control unit 14, the gating signal generation unit 40, and the signal processing unit 50. The sub-frame memory unit 72 is connected to the sub-frame output unit 56. The distance image generation unit 74 is connected to the sub-frame memory unit 72.

The pulsed light source 12 is a light source (light emitting unit) for irradiating pulsed light (irradiation light 16) to a measurement target region. The light source control unit 14 is a control circuit for controlling the light emission timing of the pulsed light source 12. The light source control unit 14 may be a direct modulation system that modulates the irradiation light 16 by controlling the current supplied to the light emitting element of the pulsed light source 12, or may be an external modulation system that modulates the light emitted from the light emitting element by a light chopper or a modulation element to obtain the irradiation light 16. In the former case, as the light emitting element constituting the pulsed light source 12, an element capable of high-speed modulation, such as an LED (Light Emitting Diode) or an LD (Laser Diode), may be applied. The light emitting element may be a VCSEL (Vertical Cavity Surface Emitting Laser) or a surface light emitting element in which the VCSELs are arranged in an array.

The light receiving unit 30 includes one or more light receiving elements (not illustrated) and has a role of detecting light from the measurement target region. The light detected by the light receiving unit 30 includes light (reflected light 18) reflected by the object 110 in the measurement target region among the irradiation light 16 emitted from the light source device 10. The light receiving element constituting the light receiving unit 30 outputs a signal corresponding to an amount of light incident during a predetermined detection period (exposure period) corresponding to a control signal from the outside (gating signal generation unit 40). The light receiving element is not particularly limited as long as it can selectively execute a light detection period and an inactive period according to a control signal from the outside, and can output a signal according to an amount of light detected during each detection period after each detection period. Examples of the light receiving element capable of having such a function include a CMOS (Complementary Metal-Oxide-Semiconductor) sensor and a SPAD (Single Photon Avalanche Diode) sensor. The light receiving unit 30 is configured by a photoelectric conversion device in which pixel circuits each including the light receiving element are two-dimensionally arranged, whereby a two-dimensional distance image may be acquired. In the following description, it is assumed that the light receiving unit 30 is an image sensor using SPAD.

The gating signal generation unit 40 is a control circuit that outputs a control signal for controlling the driving timing of the light receiving unit 30. Specifically, in response to a control signal from the control unit 60, the gating signal generation unit 40 generates a control signal for controlling the light receiving unit 30 to output a signal corresponding to an amount of light incident on the light receiving element during a predetermined exposure period, and outputs the generated control signal to the light receiving unit 30. In this specification, a control signal supplied from the gating signal generation unit 40 to the light receiving unit 30 in order to control the exposure period in the light receiving unit 30 is referred to as a gating signal.

The control unit 60 is connected also to the light source device 10, and is configured to control the exposure period of the light receiving unit 30 in synchronization with the light emission control timing of the light source device 10. This makes it possible to perform imaging in which the time difference from the time at which light is emitted from the pulsed light source 12 to the time at which light is received by the light receiving unit 30 is controlled. In the present embodiment, it is assumed that the gating signal generation unit 40 drives the light receiving unit 30 in a global gate driving system. The global gate driving is a driving method in which imaging is performed at the same time in the same exposure period in all the pixels of the light receiving unit 30 with the emission time of the pulsed light from the pulsed light source 12 as a reference. In the global gate driving of the present embodiment, imaging is repeatedly performed while sequentially shifting the global exposure timings of all the pixels.

The signal processing unit 50 has a role of performing predetermined signal processing on the signal output from the light receiving unit 30, and acquiring information on the distance to the object 110. The arithmetic processing device 70 has a role of generating a distance image based on a signal output from the light detection device 20. The arithmetic processing device 70 may be a computer including a processor that operates as the distance image generation unit 74 and a memory that operates as the sub-frame memory unit 72. Specific configurations and operations of the signal processing unit 50 and the arithmetic processing device 70 will be described later.

The distance information acquisition device 100 according to the present embodiment is a device that outputs a distance image by two-dimensionally measuring distances to a plurality of points of the object 110 existing within a predetermined range of distance measurement. The distance information acquisition device 100 measures a time difference until the light emitted from the light source device 10 is reflected by the object 110 and received by the light detection device 20. Then, the distance information acquisition device 100 calculates a distance from the distance information acquisition device 100 to the object 110 based on the measured time difference. Such a distance measurement method is called a TOF method.

Next, a configuration example of the light receiving unit 30 in the distance information acquisition device according to the present embodiment will be described with reference to FIG. 2 to FIG. 4B. Here, the light receiving unit 30 will be described by taking the SPAD image sensor as an example, but the sensor constituting the light receiving unit 30 is not limited to the SPAD image sensor.

The light receiving unit 30 includes a plurality of pixels 32 two-dimensionally arranged to form a plurality of rows and a plurality of columns. As illustrated in FIG. 2, for example, each pixel 32 may include a photoelectric conversion element PD, a quenching element 34, a waveform shaping circuit LC1, a gating circuit LC2, a counter 36, and a pixel output circuit 38. The photoelectric conversion element PD, the quenching element 34, and the waveform shaping circuit LC1 have a function as a photoelectric conversion unit that outputs a pulse signal in response to incidence of light.

The photoelectric conversion element PD may be an avalanche photodiode (hereinafter referred to as “APD”). The anode of the APD constituting the photoelectric conversion element PD is connected to a node to which a voltage VL is supplied. The cathode of the APD constituting the photoelectric conversion element PD is connected to one terminal of the quenching element 34. The other terminal of the quenching element 34 is connected to a node to which a voltage VH higher than the voltage VL is supplied. The voltage VL and the voltage VH are set such that a reverse bias voltage sufficient for the APD to perform the avalanche multiplication operation is applied. In one example, a negative high voltage is applied as the voltage VL, and a positive voltage about a power supply voltage is applied as the voltage VH. For example, the voltage VL is −30 V and the voltage VH is 1 V.

The photoelectric conversion element PD may be formed of APD as described above. By supplying a reverse bias voltage sufficient to perform the avalanche multiplication operation to the APD, charges generated by light incidence to the APD cause avalanche multiplication, and an avalanche current is generated. The operation modes in a state where a reverse bias voltage is supplied to the APD include a Geiger mode and a linear mode. The Geiger mode is an operation mode in which a voltage applied between the anode and the cathode is set to a reverse bias voltage larger than a breakdown voltage of the APD. The linear mode is an operation mode in which a voltage applied between the anode and the cathode is set to a reverse bias voltage close to or lower than a breakdown voltage of the APD. The APD operating in the Geiger mode is called SPAD. The APD constituting the photoelectric conversion element PD may operate in the linear mode or the Geiger mode.

The quenching element 34 has a function of converting a change in the avalanche current generated in the photoelectric conversion element PD into a voltage signal. Further, the quenching element 34 functions as a load circuit (quenching circuit) at the time of signal multiplication by avalanche multiplication, and has a function of reducing a voltage applied to the photoelectric conversion element PD to suppress avalanche multiplication. The operation in which the quenching element 34 suppresses avalanche multiplication is called a quenching operation. Further, the quenching element 34 has a function of returning the voltage supplied to the photoelectric conversion element PD to the voltage VH by flowing a current corresponding to the voltage drop by the quenching operation. The operation in which the quenching element 34 returns the voltage supplied to the photoelectric conversion element PD to the voltage VH is called a recharging operation. The quenching element 34 may be composed of a resistor, a MOS transistor, or the like.

The waveform shaping circuit LC1 includes an input node connected to a connection node between the photoelectric conversion element PD and the quenching element 34, and an output node. The waveform shaping circuit LC1 has a function as a waveform shaping unit that converts an analog signal supplied from the photoelectric conversion element PD into a pulse signal. The waveform shaping circuit LC1 may be configured by a logic circuit including a NOT circuit (inverter circuit), a NOR circuit, a NAND circuit, and the like.

The gating circuit LC2 has two input nodes and an output node. One input node of the gating circuit LC2 is connected to the output node of the waveform shaping circuit LC1. A gating signal PGATE supplied from the gating signal generation unit 40 is supplied to the other input node of the gating circuit LC2. The output node of the gating circuit LC2 is connected to the counter 36. The gating circuit LC2 is configured to output an output signal of the waveform shaping circuit LC1 to the counter 36 when the gating signal PGATE is at high-level. For example, as illustrated in FIG. 2, the gating circuit LC2 may be configured by a two-input AND circuit.

The counter 36 functions as a counting unit that counts the number of pulsed light beams reflected by the object 110 and incident on the light receiving unit 30. The counter 36 includes an input node to which an output signal of the gating circuit LC2 is input, an input node to which a reset signal PRES for resetting the counter 36 is input, an input node to which a clock signal CLK is input, and an output node. The counter 36 has a function of a 1-bit memory which counts pulses to be superimposed on a signal output from the gating circuit LC2 and holds a 1-bit signal in accordance with the counting result. Specifically, the counter 36 holds a value of 0 when the number of pulses input after the reset is less than a predetermined value of 2 or more, and holds a value of 1 when the number of pulses input after the reset is equal to or greater than the predetermined value of 2 or more. In the present embodiment, the 1-bit signal having the value of 1 is used as a reference for determining that pulsed light is detected. The output node of the counter 36 is connected to the output line DOUT via the pixel output circuit 38.

The pixel output circuit 38 has a function of switching an electrical connection state (connection or disconnection) between the counter 36 and the output line DOUT. The pixel output circuit 38 switches the connection state between the counter 36 and the output line DOUT in accordance with a control signal PSEL from the gating signal generation unit 40 or the control unit 60. The pixel output circuit 38 may include a buffer circuit for outputting a signal.

At least a part of the functions of the micro-frame acquisition unit 52, the micro-frame addition unit 54, and the sub-frame output unit 56 may be provided in each of the plurality of pixels 32 constituting the light receiving unit 30.

Next, a basic operation of the photoelectric conversion unit of the pixel 32 will be described with reference to FIG. 3A to FIG. 3C. FIG. 3A is an equivalent circuit diagram of the photoelectric conversion unit, FIG. 3B illustrates a waveform of a signal at an input node (node A) of the waveform shaping circuit LC1, and FIG. 3C illustrates a waveform of a signal at an output node (node B) of the waveform shaping circuit LC1.

At time t0, a reverse bias voltage of a potential difference corresponding to (VH−VL) is applied to the photoelectric conversion element PD. Although a reverse bias voltage sufficient to cause avalanche multiplication is applied between the anode and the cathode of the APD constituting the photoelectric conversion element PD, there is no carriers that become seeds of avalanche multiplication in a state where photons are not incident on the photoelectric conversion element PD. Therefore, no avalanche multiplication occurs in the photoelectric conversion element PD, and no current flows through the photoelectric conversion element PD.

At time t1, it is assumed that a photon enters the photoelectric conversion element PD. When the photon is incident on the photoelectric conversion element PD, an electron-hole pair is generated by photoelectric conversion, avalanche multiplication is generated using these carriers as a seed, and an avalanche multiplication current flows through the photoelectric conversion element PD. When the avalanche multiplication current flows through the quenching element 34, a voltage drop by the quenching element 34 occurs, and the voltage of the node A begins to drop. When the voltage drop amount of the node A increases and the avalanche multiplication stops at time t3, the voltage level of the node A does not drop any further.

When the avalanche multiplication in the photoelectric conversion element PD stops, a current that compensates the voltage drop flows from the node to which the voltage VL is supplied to the node A via the photoelectric conversion element PD, and the voltage of the node A gradually increases. Then, at time t5, node A is settled to the original voltage level.

The waveform shaping circuit LC1 binarizes the signal input from the node A according to a predetermined determination threshold value, and outputs the signal from the node B. Specifically, the waveform shaping circuit LC1 outputs a low-level signal from the node B when the voltage level of the node A exceeds the determination threshold value, and outputs a high-level signal from the node B when the voltage level of the node A is equal to or lower than the determination threshold value. For example, as illustrated in FIG. 3B, it is assumed that the voltage of the node A is equal to or lower than the determination threshold value during a period from the time t2 to the time t4. In this case, as illustrated in FIG. 3C, the signal level at the node B becomes low-level during a period from time t0 to time t2 and a period from time t4 to time t5, and becomes high-level during a period from time t2 to time t4.

In this way, the analog signal input from the node A is shaped into a digital signal by the waveform shaping circuit LC1. A pulse signal output from the waveform shaping circuit LC1 in response to incidence of a photon on the photoelectric conversion element PD is a photon detection pulse signal.

Next, a configuration example and operation of the counter 36 will be described with reference to FIG. 4A and FIG. 4B. FIG. 4A is an equivalent circuit diagram of the counter 36, and FIG. 4B is a timing diagram illustrating the operation of the counter 36.

For example, as illustrated in FIG. 4A, the counter 36 may be configured by sequential circuits including flip-flops FF1, FF2, and FF3 and a logic circuit LC3. The flip-flops FF1 and FF3 may be RS flip-flops and the flip-flop FF2 may be D flip-flops. The RS flip-flop has two input nodes (S terminal and R terminal) and two output nodes (Q terminal and Qb terminal). The D flip-flop includes two input nodes (D terminal and CK terminal) and two output nodes (Q terminal and Qb terminal). Logic circuit LC3 may be a two-input AND circuit.

The S terminal of the flip-flop FF1 is connected to the output node of the gating circuit LC2. A signal C_IN, which is an output signal of the gating circuit LC2, is input to the S terminal of the flip-flop FF1, and the reset signal PRES is input to the R terminal of the flip-flop FF1. The Q terminal of the flip-flop FF1 is connected to the D terminal of the flip-flop FF2. The output signal Q of the flip-flop FF1 is input to the D terminal of the flip-flop FF2, and the clock signal CLK is input to the CK terminal of the flip-flop FF2. One input node of the logic circuit LC3 is connected to the output node of the gating circuit LC2, and the other input node of the logic circuit LC3 is connected to the Q terminal of the flip-flop FF2. A signal C_IN and an output signal Q of the flip-flop FF2 are input to the logic circuit LC3. The output node of the logic circuit LC3 is connected to the S terminal of the flip-flop FF3. The output signal of the logic circuit LC3 is input to the S terminal of the flip-flop FF3, and the reset signal PRES is input to the R terminal of the flip-flop FF3. A signal output from the Q terminal of the flip-flop FF3 is a signal C_OUT which is an output signal of the counter 36.

In a reset state reset in response to the reset signal PRES, it is assumed that output signals Q of the flip-flops FF1, FF2, and FF3 are all zero. In this state, as illustrated in FIG. 4B, it is assumed that the signal C_IN transitions to high-level at times t1, t3, t5, and t7, and the clock signal CLK transitions to high-level at times t2, t4, t6, and t8.

When the signal C_IN becomes high-level at the time t1, the flip-flop FF1 receives a high-level input to the S terminal and becomes a set state, and the output signal Q becomes high-level. Although the high-level signal C_IN is also input to one input node of the logic circuit LC3, the other input node of the logic circuit LC3 receives the output signal Q of the flip-flop FF2 that is at low-level, and the S terminal of the flip-flop FF3 is at low-level. Thereby, the output signal Q of the flip-flop FF3, i.e., the signal C_OUT, is at low-level (value 0).

When the clock signal CLK becomes high-level at the time t2, the output signal Q of the flip-flop FF2 becomes high-level by receiving a high-level input to the D terminal. At this time, the signal C_IN is at low-level, and the signal C_OUT remains at low-level.

When the signal C_IN becomes high level at the time t3, the output of the logic circuit LC3 receives the high-level signal C_IN and the high-level output signal Q, and becomes high-level. As a result, the flip-flop FF3 becomes the set state by receiving the high-level input to the S terminal, and the output signal Q becomes high-level. That is, the signal C_OUT transitions from low-level (value 0) to high-level (value 1).

After that, even when the signal C_IN or the clock signal CLK transitions to high-level from the time t4 to the time t8, the states of the flip-flops FF1, FF2, and FF3 do not change, so that the signal level of the signal C_OUT does not change.

That is, the counter 36 illustrated in FIG. 4A constitutes a 1-bit counter in which the value is 0 when the number of input pulses superimposed on the signal C_IN is less than 2, and the value is 1 when the number of input pulses superimposed on the signal C_IN becomes 2 or more. In the configuration example of FIG. 4A, a threshold value of the number of pulses at which the level of the signal C_OUT transitions is 2, but the threshold value may be set to an arbitrary value equal to or greater than 2. The threshold value of the counter 36 may be changed, for example, by increasing the number of stages of the flip-flops.

After the count value of the counter 36 transitions to 1, the state of the counter 36 does not change. Therefore, the output signal Q of the flip-flop FF3 or the inverted signal Qb thereof may be fed back to the quenching element 34 to control the photoelectric conversion element PD so that the avalanche multiplication operation does not occur after the count value has transitioned to 1. With such a structure, power consumption may be reduced.

In addition to the sequential circuits illustrated in FIG. 4A, the counter 36 may be configured using an N-ary counter circuit. Here, N is a threshold value of the number of pulses at which the level of the signal C_OUT transitions. By setting the input of the N-ary counter to the signal C_IN and the value of the second digit of the N-ary counter to the signal C_OUT, the value of the second digit rises when the number of input pulses becomes N and becomes 1. Then, by holding the value of the second digit to 1, the same operation as that of the sequential circuit of FIG. 4A may be realized.

Next, configurations of a ranging frame, a sub-frame, and a micro-frame used for generating a distance image in the distance information acquisition device 100 according to the present embodiment will be described with reference to FIG. 5. In the upper part of FIG. 5, an acquisition period of each of the ranging frames each corresponding to a distance image, the sub-frames used for generating the ranging frame, and the micro-frames used for generating the sub-frame are schematically illustrated by arranging blocks in the horizontal direction. The horizontal direction in FIG. 5 indicates the elapse of time, and one block indicates the acquisition period of one ranging frame, sub-frame, or micro-frame.

The ranging frame F1 corresponds to one distance image. That is, the ranging frame F1 has information corresponding to the distance to the object 110 calculated from the time difference from the light emission to the light reception for each of the plurality of pixels 32 constituting the light receiving unit 30. In the present embodiment, it is assumed that a distance image is acquired as a moving image, and one ranging frame F1 is repeatedly acquired every time one ranging frame period T1 elapses. FIG. 5 illustrates a first ranging frame and a second ranging frame following the first ranging frame among a plurality of consecutive ranging frames F1.

One ranging frame F1 is generated from a plurality of sub-frames F2. One ranging frame period T1 includes a plurality of sub-frame periods T2. Every time one sub-frame period T2 elapses, one sub-frame F2 is repeatedly acquired. The sub-frame F2 is composed of a plurality of bit signals corresponding to an amount of light detected during the sub-frame period T2. The number of sub-frames F2 constituting one ranging frame F1 is not particularly limited.

One sub-frame F2 is generated from a plurality of micro-frames F3. One sub-frame period T2 includes a plurality of micro-frame periods T3. Every time one micro-frame period T3 elapses, one micro-frame F3 is repeatedly acquired. The micro-frame F3 is composed of a 1-bit signal indicating the presence or absence of incident light to the photoelectric conversion element in the micro-frame period T3. By additively composing a plurality of micro-frames of a one-bit signal, one sub-frame F2 of a plurality of bit signals is generated. Thus, one sub-frame F2 may include a plurality of bit signals corresponding to the number of micro-frames in which incident light is detected within the sub-frame period T2. The number of the micro-frames F3 constituting one sub-frame F2 is not particularly limited.

The lower part of FIG. 5 illustrates an outline of the operation of the distance information acquisition device 100 in the micro-frame F3. The light emission control signal is a control signal output from the light source control unit 14 to the pulsed light source 12, and high-level periods indicate that the pulsed light source 12 emits light. The gating signal PGATE is a control signal output from the gating signal generation unit 40 to each pixel 32 of the light receiving unit 30, and high-level periods indicate the periods during which light can be detected by the pixels 32.

During the micro-frame period T3, the light emission control signal is controlled to be periodically at high-level at a constant period T. The pulsed light source 12 outputs the irradiation light 16 during a period in which the pulsed light source 12 receives the high-level emission control signal, and does not output the irradiation light 16 during a period in which the pulsed light source 12 receives the low-level emission control signal. The relationship between the signal level of the light emission control signal and the ON/OFF operation of the pulsed light source 12 may be arbitrarily set.

The gating signal PGATE is controlled to be at high-level with a delay of a predetermined time (delay time: t_{D}) during the period T with respect to each period during which the light emission control signal is at high-level. A period in which the gating signal PGATE is at high-level corresponds to a period in which the light receiving unit 30 is controlled to be in an active state in which light can be detected, and a period in which the gating signal PGATE is at low-level corresponds to a period in which the light receiving unit 30 is controlled to be in an inactive state in which light is not detected. The gating signal PGATE is generated by the gating signal generation unit 40, but is generated by the control unit 60 at a timing synchronized with the light emission control signal so as to have a predetermined delay time with respect to the light emission control signal. The delay time for the emission control signal of the gating signal PGATE is set to a different time for each sub-frame F2. The relationship between the signal level of the gating signal PGATE and the operation of the light receiving unit 30 may be arbitrarily set.

Each pixel 32 constituting the light receiving unit 30 is in an active state (ON) in which light can be detected in a period in which the gating signal PGATE is at high-level, and is in an inactive state in which light is not detected in a period in which the gating signal PGATE is at low-level. Each pixel 32 is configured to output a 1-bit signal indicating data held by the counter 36 to the micro-frame acquisition unit 52 after the micro-frame period T3 has elapsed.

The relationship between the light emission control signal and the gating signal PGATE will be described in detail with reference to FIG. 6. Here, as illustrated in FIG. 6, a region X in which the distance from the light source device 10 and the light receiving unit 30 is L and the thickness in the depth-wise direction is LX is assumed in a measurement target region 80 which is an irradiation region of light (irradiation light 16) emitted from the light source device 10. In this case, the optical path length of the reflected light 18 (solid line in the figure) emitted from the light source device 10 and reflected at a position of a surface of the region X on a side of the light source device 10 and the light receiving unit 30 to reach the light receiving unit 30 is 2L. On the other hand, the optical path length of the reflected light 18 (broken line in the figure) emitted from the light source device 10 and reflected at a position of a surface of the region X opposite to the light source device 10 and the light receiving unit 30 to reach the light receiving unit 30 is 2×(L+LX). The difference in optical path length causes a time difference between the timing at which the light reflected at the position on the side of the light source device 10 and the light receiving unit 30 in the region X reaches the light receiving unit 30 and the timing at which the light reflected at the position on the side opposite to the light source device 10 and the light receiving unit 30 in the region X reaches the light receiving unit 30. This time difference is expressed as 2LX/c where c is the speed of light.

By setting the light receiving unit 30 to the detection period only during the period corresponding to the time difference, it is possible to selectively acquire information of the measurement object positioned in the region X in the measurement target region 80. That is, in FIG. 5, the time period from the timing at which the light emission control signal becomes high-level to the timing at which the gating signal PGATE becomes high-level is set to a time period corresponding to the distance of 2L, and the time width of the gating signal PGATE is set to a time period corresponding to the distance of 2LX. By setting the detection period of the light receiving unit 30 in this manner, it is possible to acquire the micro-frame F3 including the information of the object to be measured positioned in the region X.

Here, assuming that the range of the distance L to the thickness LX set in the detection period of the light receiving unit 30 is referred to as a measurement target distance range, the plurality of sub-frames F2 constituting the ranging frame F1 have different measurement target distance ranges. The measurement target distance ranges of the plurality of micro-frames F3 constituting one sub-frame F2 are the same. Further, when a period during which the gating signal PGATE becomes high-level corresponding to the measurement target distance range is referred to as a gating period, a plurality of sub-frames F2 constituting the ranging frame F1 have different gating periods. A plurality of micro-frames F3 constituting one sub-frame F2 have the same gating period.

In the present embodiment, a plurality of sub-frames F2 are acquired while sequentially shifting the measurement target distance range. That is, by sequentially switching the detection period allowing detection of the pulsed light to the light receiving unit 30, the pulsed light corresponding to each of the plurality of measurement target distance ranges constituting the measurement target area is detected in a time division manner. With this configuration, the distribution of the signal values of the sub-frame F2 with respect to the distance to be measured may be obtained. Since the measurement target distance range in which the signal value is maximized is estimated as a region in which the object 110 reflecting the irradiation light 16 exists, the distance to the object 110 may be calculated from the measurement target distance range in which the signal value is maximized. Further, a distance image may be generated by calculating a distance for each pixel and acquiring a two-dimensional distribution of the distance.

Next, a method of driving the distance information acquisition device according to the present embodiment will be described with reference to FIG. 7. FIG. 7 illustrates an example of a driving method capable of acquiring a ranging frame, a sub-frame, and a micro-frame as illustrated in FIG. 5. FIG. 7 illustrates a driving method of the distance information acquisition device in one ranging frame period T1.

In the flowchart illustrated in FIG. 7, a series of processing from “start” to “end” is performed in a ranging frame period T1 in which one ranging frame F1 in FIG. 5 is acquired. The processing of one cycle in the loop from step S102 to step S108 is performed in a sub-frame period T2 in which one sub-frame F2 in FIG. 5 is acquired. The processing of one cycle in the loop from step S103 to step S105 is performed in the micro-frame period T3 in which one micro-frame F3 in FIG. 5 is acquired.

First, in step S101, the control unit 60 sets an initial value of the gating period in the gating signal generation unit 40. The initial value of the gating period is not particularly limited, and may be set, for example, to a gating period corresponding to a measurement target distance range closest to the distance information acquisition device 100 among a plurality of measurement target distance ranges set in the measurement target region.

Next, in step S102, the control unit 60 initializes a flag variable i used for counting the micro-frame F3 constituting one sub-frame F2 to 1. It is assumed that the number of the micro-frames F3 constituting the one sub-frame F2 is N (for example, 64).

Next, in step S103, a micro-frame is acquired. The control unit 60 controls the pulsed light source 12 via the light source control unit 14, and emits pulsed light to the measurement target region. In synchronization with this, the control unit 60 controls the light receiving unit 30 to start imaging by global gate driving. At this time, the gating signal generation unit 40 outputs the gating signal PGATE corresponding to the set gating period to the light receiving unit 30. The light receiving unit 30 acquires information of the measurement target distance range corresponding to the gating period. After a predetermined micro-frame period T3 has elapsed, the micro-frame acquisition unit 52 reads out a micro-frame composed of a 1-bit signal held by the counter 36 from each pixel 32 of the light receiving unit 30. In this way, the micro-frame acquisition unit 52 functions as an acquisition unit that acquires a micro-frame composed of a 1-bit signal based on incident light to the photoelectric conversion element.

The micro-frame read out from the light receiving unit 30 is held in the memory of the micro-frame addition unit 54. This memory has a storage capacity capable of holding data of a plurality of bits for each pixel. The micro-frame addition unit 54 sequentially adds the value of the micro-frame to the value held in the memory every time the micro-frame is read out, and stores the value after added. Thus, the micro-frame addition unit 54 functions as a composing unit for composing micro-frames acquired in different periods.

Next, in step S104, it is determined whether or not the number of acquired micro-frames (the flag variable i) has reached a predetermined value N. As a result of the determination, if the number of acquired micro-frames does not reach the predetermined value N (“NO” in step S104), the flag variable i is added by 1 in step S105, and the process returns to step S103. As a result of the determination, if the number of acquired micro-frames is the predetermined value N (“YES” in step S104), the process proceeds to step S106. At this time, data (sub-frame) obtained by accumulating the values of N-number of micro-frames is held in the memory of the micro-frame addition unit 54. For example, when N is 64, 6-bit gradation scale data may be output.

Next, in step S106, the sub-frame output unit 56 reads out the sub-frame generated by accumulating the values of the N-number of micro-frames from the memory. The sub-frame output unit 56 converts a signal read out from the memory according to an appropriate output interface standard, and outputs the converted signal to the sub-frame memory unit 72 by serial communication. The sub-frame memory unit 72 stores the sub-frame output from the sub-frame output unit 56. The sub-frame memory unit 72 is configured to store a plurality of sub-frames used for generating one ranging frame individually for each sub-frame period.

Next, in step S107, it is determined whether all the sub-frames (M-number of sub-frames) corresponding to each of the measurement target distance ranges constituting the one ranging frame have been acquired. If it is determined that all the sub-frames constituting the ranging frame have not been acquired (“NO” in step S107), the gating period is shifted to a gating period corresponding to another measurement target distance range in step S108, and the process returns to step S102. For example, the measurement target distance range may be sequentially shifted from a side closer to the distance information acquisition device 100 to a side farther from the distance information acquisition device 100. If it is determined that all the sub-frames constituting the ranging frame are acquired (“YES” in step S107), the process proceeds to step S109. At this time, M-number of sub-frames constituting one ranging frame are held in the sub-frame memory unit 72.

In step S109, the distance image generation unit 74 acquires a plurality of sub-frames in one ranging frame period from the sub-frame memory unit 72. The distance image generation unit 74 extracts a sub-frame having the largest signal value for each pixel, and calculates a measurement target distance range corresponding to the extracted sub-frame. That is, the distance image generation unit 74 determines the distance range to be measured or the class value thereof calculated in this manner as a distance measurement result of the object for the pixel. In this way, the distance image generation unit 74 generates a distance image indicating a two-dimensional distribution of distances. The distance image generation unit 74 outputs the generated distance image to an external device of the arithmetic processing device 70. This distance image may be used, for example, to detect the surrounding environment of the vehicle. The distance image generation unit 74 may be configured to store the distance image in a memory inside the distance information acquisition device 100.

By a series of operations from step S101 to step S109, one ranging frame composed of M-number of sub-frames may be acquired. When the distance image is a moving image, the operation of steps S101 to S109 may be repeated to repeatedly acquire the ranging frame.

In the present embodiment, as described above, when the micro-frame is acquired, the photon detection pulse signal that has passed through the gating circuit LC2 during the detection period of the light receiving unit 30 is counted by the 1-bit counter 36 whose value becomes 1 when a pulse is received a predetermined number of times or more. The reason why the counter 36 is configured in this manner in the present embodiment will be described below.

In the case where an object exists in the measurement target distance range corresponding to a certain gating period, if it is a conditions under which a large amount of reflected light returns in response to the irradiation of the pulsed light, the reflected light would be detected a plurality of times when the irradiation of pulsed light is performed a plurality of times during one micro-frame period. On the other hand, in the case where an object does not exist in the measurement target distance range corresponding to a certain gating period, reflected light would not be detected even if the pulsed light is irradiated a plurality of times during one micro-frame period. However, in practice, in addition to the reflected light from the object, disturbance light generated at random and noise caused by the SPAD element may occur, and even when the object does not exist in the measurement target distance range corresponding to the gating period, a false signal may be detected at random. In such a case, when a sub-frame of a certain pixel is represented in a frequency distribution with a measurement target distance range as a class (bin), for example, as illustrated in FIG. 8, a false signal due to noise may be detected in the bins other than the bin 10 corresponding to the measurement target distance range in which an object exists.

In this respect, in the present embodiment, the counter 36 is configured such that the output becomes 1 when the photon detection pulse signal is received a predetermined number of times or more. Therefore, when there is no object in the measurement target distance range, the output becomes 0 even when the noise is detected a number of times less than the predetermined number of times, and the influence of the false signal due to the noise hardly appears on the output. As a result, for example, as illustrated in FIG. 9, it is possible to acquire an output histogram in which influence of noise is reduced, and it is possible to improve detection accuracy of distance information.

As described above, according to the present embodiment, in the distance information acquisition device and the distance information acquisition method for measuring the distance to the object using light, it is possible to obtain the distance information with higher accuracy by reducing the influence of noise.

### Second Embodiment

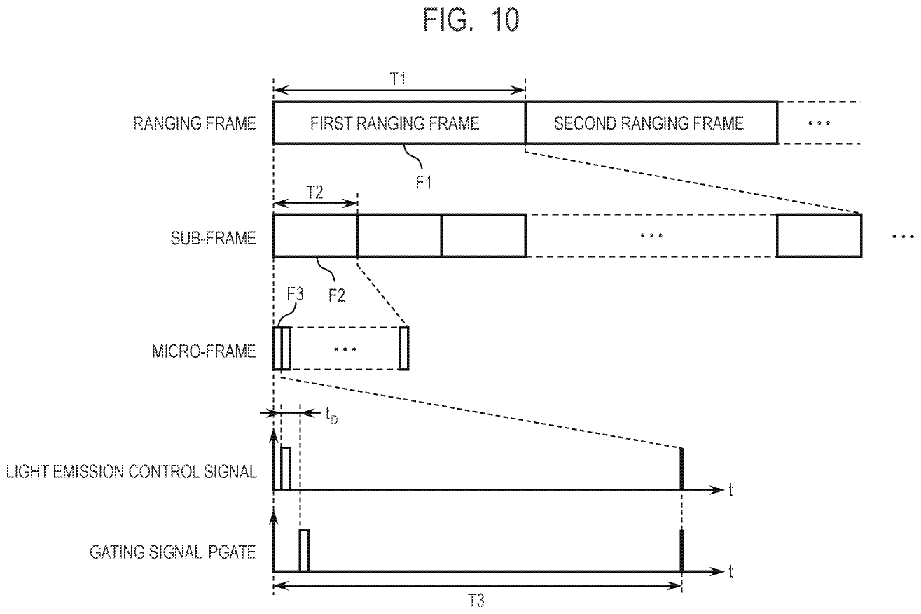

A distance information acquisition device and a distance information acquisition method according to a second embodiment of the present invention will be described with reference to FIG. 10. Components similar to those of the distance information acquisition device according to the first embodiment are denoted by the same reference numerals, and description thereof will be omitted or simplified. FIG. 10 is a diagram illustrating a configuration example of a ranging frame in the distance information acquisition method according to the present embodiment.

The distance information acquisition device and the distance information acquisition method according to the present embodiment are the same as the distance information acquisition device and the distance information acquisition method according to the first embodiment except that the definition of the micro-frame is different. Hereinafter, the distance information acquisition device and the distance information acquisition method according to the present embodiment will be described mainly with respect to points different from those of the distance information acquisition device and the distance information acquisition method according to the first embodiment, and a description of common points will be appropriately omitted.

The configurations of a ranging frame, a sub-frame, and a micro-frame used for generating a distance image in the distance information acquisition device 100 according to the present embodiment will be described with reference to FIG. 10. In the upper part of FIG. 10, an acquisition period of each of the ranging frames each corresponding to a distance image, the sub-frames used for generating the ranging frame, and the micro-frames used for generating the sub-frame are schematically illustrated by arranging blocks in the horizontal direction. The horizontal direction in FIG. 10 indicates the elapse of time, and one block indicates the acquisition period of one ranging frame, sub-frame, or micro-frame.

The hierarchical configuration of the ranging frame, the sub-frame, and the micro-frame in the present embodiment is similar to that of the first embodiment. That is, one ranging frame F1 is generated from a plurality of sub-frames F2. One ranging frame period T1 includes a plurality of sub-frame periods T2. One sub-frame F2 is generated from a plurality of micro-frames F3. One sub-frame period T2 includes a plurality of micro-frame periods T3.

The present embodiment is different from the first embodiment in the operation of the distance information acquisition device 100 in the micro-frame F3. That is, in the first embodiment, a plurality of times of irradiation of the pulsed light is performed during one micro-frame period T3, and a plurality of times of gating periods corresponding to each of the plurality of times of irradiation of the pulsed light are set. On the other hand, in the present embodiment, one irradiation of the pulsed light is performed during one micro-frame period T3, and one gating period corresponding to the one irradiation of the pulsed light is set.

The counter 36 of each pixel 32 is a 1-bit counter that outputs a 1-bit signal in accordance with the number of photon detection pulses output from the gating circuit LC2. The counter 36 has a function of a 1-bit memory which counts pulses to be superimposed on a signal output from the gating circuit LC2 and holds a 1-bit signal in accordance with the counting result. Specifically, the counter 36 holds a value of 0 when a photon detection pulse corresponding to one pulsed light irradiation is not input, and holds a value of 1 when a photon detection pulse corresponding to one pulsed light irradiation is input. For example, referring to the circuit diagram of FIG. 4A, the output signal of the counter 36 in the present embodiment may be the output signal Q of the flip-flop FF1. The output node of the counter 36 is connected to the output line DOUT via the pixel output circuit 38.

The micro-frame addition unit 54 has a function of a 1-bit memory which performs addition processing of the micro-frames read out from the light receiving unit 30 by the micro-frame acquisition unit 52, and holds a 1-bit signal corresponding to the addition result. Specifically, the micro-frame addition unit 54 holds a value of 0 when the number of micro-frames having the value of 1 is less than a predetermined value of 2 or more, and holds a value of 1 when the number of micro-frames having the value of 1 is greater than or equal to a predetermined value of 2 or more. One-bit data obtained by adding the values of N-number of micro-frames is a sub-frame in the present embodiment.

In the present embodiment, it is not always necessary to shift the gating period every time the sub-frame ends, and a plurality of sub-frames may be executed for each of the gating periods.

As described above, according to the present embodiment, in the distance information acquisition device and the distance information acquisition method for measuring the distance to the object using light, it is possible to obtain the distance information with higher accuracy by reducing the influence of noise.

### Third Embodiment

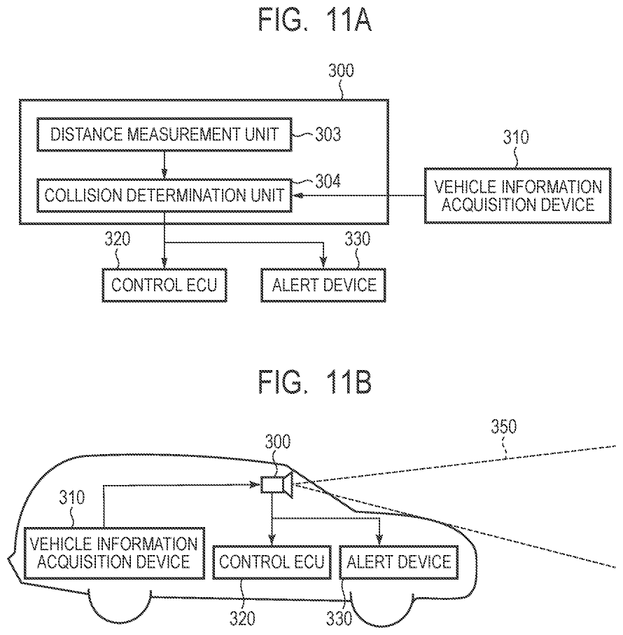

A movable object according to a third embodiment of the present invention will be described with reference to FIG. 11A and FIG. 11B. FIG. 11A and FIG. 11B are diagrams illustrating a configuration example of a movable object according to the present embodiment.

FIG. 11A illustrates a configuration example of equipment mounted on a vehicle as an on-vehicle camera. The equipment 300 includes a distance measurement unit 303 that measures a distance to an object, and a collision determination unit 304 that determines whether or not there is a possibility of collision based on a distance measured by the distance measurement unit 303. The distance measurement unit 303 may be configured by the distance information acquisition device 100 described in the first or second embodiment. The distance measurement unit 303 is an example of a distance information acquisition unit that obtains distance information to the object. That is, the distance information is information on a distance to the object and the like.

The equipment 300 is connected to the vehicle information acquisition device 310, and may obtain vehicle information such as a vehicle speed, a yaw rate, and a steering angle. Further, a control ECU 320, which is a control device for outputting a control signal for generating a braking force to the vehicle based on the determination result of the collision determination unit 304, is connected to the equipment 300. The equipment 300 is also connected to an alert device 330 that issues an alert to the driver based on the determination result of the collision determination unit 304. For example, when the collision possibility is high as the determination result of the collision determination unit 304, the control ECU 320 performs vehicle control to avoid collision and reduce damage by braking, returning an accelerator, suppressing engine output, or the like. The alert device 330 alerts the user by sounding an alarm such as a sound, displaying alert information on a screen of a car navigation system or the like, or giving vibration to a seat belt or a steering wheel. These devices of the equipment 300 function as a movable object control unit that controls the operation of controlling the vehicle as described above.

In the present embodiment, the equipment 300 measures the distance around the vehicle, for example, the front or the rear. FIG. 11B illustrates a device when distance measurement is performed in front of the vehicle (distance measurement range 350). The vehicle information acquisition device 310 as the distance measurement control unit sends an instruction to the equipment 300 or the distance measurement unit 303 to perform the distance measurement operation. With such a configuration, the accuracy of distance measurement may be further improved.

Although an example in which control is performed so as not to collide with other vehicles has been described here, the present invention is also applicable to control of automatic driving following other vehicles, control of automatic driving so as not to go out of a lane, and the like. Further, the equipment is not limited to a vehicle such as an automobile, and may be applied to a movable object (movable device) such as a ship, an aircraft, an artificial satellite, an industrial robot, or a consumer robot. In addition, the present invention may be applied not only to a movable object but also to a wide variety of equipment using object recognition or biological recognition, such as an ITS (Intelligent Transport Systems) and a monitoring system.

### Modified Embodiments

The present invention is not limited to the above-described embodiments, and various modifications are possible.

For example, an example in which some of the configurations of any of the embodiments are added to other embodiments or an example in which some of the configurations of any of the embodiments are substituted with some of the configurations of the other embodiments is also an embodiment of the present invention.

Further, the distance information acquisition device according to the first and second embodiments is configured to determine a 1-bit signal indicating the presence of an object when a photon detection pulse is detected twice or more in a gating period in which the measurement target distance range is the same. However, the configuration of the present invention may be applied to a distance measuring device other than the distance measuring device that performs gating system. For example, the present invention may be applied to a distance measuring device using TDC (Time to Digital Converter) which measures a time period from a timing at which the pulsed light is irradiated to a timing at which the pulsed light is detected by the photoelectric conversion element. In this case, the time from the emission of the pulsed light to the detection is measured, and the pulsed light is counted as the frequency of the distance range corresponding to the time.

The configuration of the present invention may also be applied to a photoelectric conversion device other than the photoelectric conversion device intended for distance measurement, for example, a two-dimensional imager or an X-ray detection sensor. Also in this case, the influence of the noise superimposed on the output of the photoelectric conversion element may be reduced by outputting a one-bit signal as the photon detection output signal when the photon enters the photoelectric conversion element twice or more in the photon counting period.

When acquiring a binarized image (black-and-white image) by an X-ray sensor or the like, image information is usually acquired by a plurality of bits, and then processing is performed by another system. When the present invention is applied, this binarization processing may be performed inside the sensor. In this case, when photon counting is detected twice or more in the sensor (in this case, this number becomes a threshold value for binarization), a detection signal of one bit may be output. With this configuration, it is possible to perform high-speed binarization processing inside the sensor without using a separate system outside the sensor.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-164599, filed Oct. 13, 2022 which is hereby incorporated by reference herein in its entirety.

What is claimed is:

1. A distance information acquisition device comprising:
a light receiving unit including a photoelectric conversion unit and configured to detect a pulsed light emitted from a light emitting unit and reflected by an object in a measurement target area; and
a signal processing unit configured to acquire information concerning a distance to the object based on information detected by the light receiving unit,
wherein the light receiving unit includes a counting unit configured to count the number of pulsed light reflected by the object and incident on the light receiving unit,
wherein the counting unit is configured to
count the number of pulsed light detected in each of a plurality of distance ranges defined according to a time period from a timing at which the pulsed light is emitted by the light emitting unit to a timing at which the pulsed light is detected by the light receiving unit, and
output one-bit signals each indicating that the pulsed light is detected, when a count value of the pulsed light is equal to or greater than a predetermined value of 2 or more,
wherein each of the one-bit signals constitutes a micro-frame,
wherein a plurality of micro-frames acquired for the same distance range constitutes a sub-frame, and
wherein a plurality of sub-frames acquired for different distance ranges constitutes a ranging frame used for generating one distance image.

2. The distance information acquisition device according to claim 1, wherein the signal processing unit includes a memory of plural bits, and is configured to store each of plural bit signals acquired by accumulating values of a plurality of one-bit signals for each distance ranges output from the counting unit in the memory.

3. The distance information acquisition device according to claim 2, wherein the signal processing unit determines a distance range having a plural bit signal of largest value as a distance measurement result of the object.

4. The distance information acquisition device according to claim 1, wherein the light receiving unit is configured to detect the pulsed light corresponding to each of the plurality of distance ranges in a time division manner by switching a detection period allowing detection of the pulsed light.

5. The distance information acquisition device according to claim 1 further comprising a distance image generation unit configured to generate a distance image indicating a distance to the object based on the ranging frame.

6. The distance information acquisition device according to claim 1, wherein the counting unit includes an N-ary counter where N is the predetermined value.

7. The distance information acquisition device according to claim 1,
wherein the photoelectric conversion unit includes a SPAD, and
wherein the counting unit is configured to count a photon detection pulse output from the photoelectric conversion unit.

8. The distance information acquisition device according to claim 1,
wherein the light receiving unit includes a plurality of pixels each including the photoelectric conversion unit and the counting unit, and
wherein the signal processing unit is configured to acquire information concerning a distance to the object for each of the plurality of pixels.

9. A distance information acquisition device comprising:
a light receiving unit including a photoelectric conversion unit and configured to detect a pulsed light emitted from a light emitting unit and reflected by an object in a measurement target area; and
a signal processing unit configured to acquire information concerning a distance to the object based on information detected by the light receiving unit,
wherein the light receiving unit includes a counting unit configured to count the number of pulsed light reflected by the object and incident on the light receiving unit,
wherein the counting unit is configured to
count the number of pulsed light detected in each of a plurality of distance ranges defined according to a time period from a timing at which the pulsed light is emitted by the light emitting unit to a timing at which the pulsed light is detected by the light receiving unit, and
output one-bit signals each indicating that the pulsed light is detected, when a count value of the pulsed light is equal to or greater than a predetermined value of 2 or more,
wherein the light receiving unit is configured to detect the pulsed light corresponding to each of the plurality of distance ranges in a time division manner by switching a detection period allowing detection of the pulsed light,
wherein each of signals input to the counting unit from the photoelectric conversion unit during the detection period constitute a micro-frame,
wherein the one-bit signal acquired by processing a plurality of micro-frames acquired for the same distance range by the counting unit constitutes a sub-frame, and
wherein a plurality of sub-frames acquired for different distance ranges constitutes a ranging frame used for generating one distance image.

10. A photoelectric conversion device comprising:
a photoelectric conversion unit including a photoelectric conversion element and configured to output a pulsed signal in response to an incident of photon; and
a counting unit configured to count the number of pulsed light output from the photoelectric conversion unit,
wherein the counting unit is configured to output a one-bit signal indicating that the pulsed light is detected, when a count value of the pulsed light is equal to or greater than a predetermined value of 2 or more.

11. The photoelectric conversion device according to claim 10 comprising a plurality of pixels each including the photoelectric conversion unit and the counting unit, and configured to output the one-bit signal from each of the plurality of pixels.

12. The photoelectric conversion device according to claim 10 further comprising a signal processing unit configured to generate a plural bit signal by accumulating values of a plurality of one-bit signals output from the counting unit.

13. The photoelectric conversion device according to claim 12 comprising a plurality of pixels each including the photoelectric conversion unit and the counting unit,
wherein the signal processing unit is configured to accumulate values of the plurality of one-bit signals output from each of the plurality of pixels for each pixel.

14. The photoelectric conversion device according to claim 10,
wherein the photoelectric conversion unit includes a SPAD, and
wherein the counting unit is configured to count a photon detection pulse output from the photoelectric conversion unit.

15. A movable object comprising:
the distance information acquisition device according to claim 1; and
a control unit configured to control the movable object based on distance information acquired by the distance information acquisition device.

16. A distance information acquisition method of acquiring distance information concerning an object based on a detection timing of light irradiated to the object, the method comprising:
irradiating a pulsed light to a measurement target area and detecting the pulsed light reflected by the object in the measurement target area;
counting the number of the pulsed light detected in each of a plurality of distance range defined according to a time period from a timing at which the pulsed light is emitted to a timing at which the pulsed light is detected;
outputting a one-bit signal indicating that the pulsed light is detected, when a count value of the pulsed light is equal to or greater than a predetermined value of 2 or more; and
calculating a plural bit signal by accumulating values of a plurality of one-bit signals for each distance ranges, and determining a distance range having a plural bit signal of largest value as a distance measurement result of the object.
